(19) United States
(12) Patent Application Publication
(10) Pub. No.: US 2010/0083469 A1
(43) Pub. Date: Apr. 8, 2010

(54) REUSABLE CARRYING HANDLE WITH A CABLE TIE

(75) Inventor: Brian H. Welker, Fulshear, TX (US)

Correspondence Address: HUSCH BLACKWELL SANDERS LLP, 190 Carondelet Plaza, Suite 600, ST. LOUIS, MO, 63105, US

(73) Assignee: WELKER, INC., Sugar Land, TX (US)

(21) Appl. No.: 12/246,470

(22) Filed: Oct. 6, 2008

(51) Int. Cl. A47J 45/07; B65D 63/00

(52) U.S. Cl. 16/425; 24/16 R

(57) ABSTRACT

The present invention relates to various embodiments of a reusable handle with a cable tie for carrying a bag. A handle can be connected to an open end of a bag by means of a cable tie to provide a bag carrying system. The present handle generally comprises a body having a hand-grip portion and a strap receiving channel defined therein; and a mounting section attached to the body, the mounting section including a socket defined therein and adapted for receiving a cable tie such that a locking head of the cable tie is held in place within the socket. A distal end of the strap is inserted through the socket, through the strap receiving channel and through the strap receiving opening of the cable tie to form a loop such that the strap is locked within the locking head.

### BACKGROUND OF THE INVENTION

The present invention relates to a carrying handle with cable ties and more particularly, to a reusable handle with a cable tie adapted for carrying a bag or article.

Frequent and apparently increasing flood conditions caused by unprecedented rain and rapid snow melts in conjunction with the inability of levies and dikes to contain the increased flow has resulted in the loss of life and damage to property. There are numerous ideas for transportable flood control devices, some employing absorption, some employing angular dimensioning, and others using assorted combinations of sheathing, stacking, or reinforcing members and numerous other devices. However, it appears that sandbags are still the primary flood mitigation system commonly used.

Recently, millions of sandbags are transported to be put into levies for blocking floodwater. Thousands of military and public workers transport the sandbags to levies to keep floodwaters out of town. Since workers typically carry a single heavy sandbag with both hands, it would take a long time to transport the sandbags. Thus, they limit the number of sandbags transported by a single worker in a limited time period. Therefore, a handle with a strap for carrying a bag which would allow a single worker to carry at least two sandbags with each hand is desirable.

There are several examples in the prior art which allow a person to carry an article or bag with a handle.

U.S. Pat. Pub. No. 2006/0012199 discloses cable ties having a handle for transporting articles secured by the cable tie. The cable tie may include a shackle and a shackle lock, wherein the shackle is inserted into the shackle lock where it may be engaged thereby and held fixed, reversibly or releasably, thereby holding an article encircled by the shackle. Since the cable ties and handles are molded with or integrally attached to the handle, the apparatus may not be reused.

U.S. Pat. Pub. No. 2007/0152460 also discloses an adjustable strap with an integral carrying handle. The adjustable strap comprises a handle, a strap for bundling one or a plurality of articles, a lock/release member for locking and releasing the strap, and an extended portion of the handle for anchoring the lock/release member. This design is also a single use product because the cable ties and handles are molded with or integrally attached to the handle.

In contrast, the handle is more expensive and if properly designed could be reused. A cable tie is an economical mass-produced item that ensures a strong, reliable connection.

In this regard, in an effort to overcome the aforementioned shortcomings, the present invention provides a reusable handle with a disposable cable tie that facilitates efficient transportation of articles, such as sandbags, without elaborate and expensive strap constructions. It is of particular advantage to provide a reusable handle to be used with any suitable commercially available cable tie.

Specific advantages and features of the invention will be apparent from the attached drawings and description of an illustrative embodiment of the present invention.

### BRIEF SUMMARY OF THE INVENTION

The present invention relates to various embodiments of a reusable handle with a cable tie for carrying a bag and especially sandbags. The present invention overcomes many of the shortcomings and limitations of the prior art devices discussed above and teaches the construction and operation of several embodiments of a reusable handle with a cable tie for carrying a bag. In one aspect of the present invention, the present reusable handle with a cable tie assembly comprises a handle and a cable tie coupleable with the handle. A handle can be connected to an open end of a bag by means of a cable tie to provide a bag carrying system. The present handle generally comprises a body, a mounting section adapted for connecting a cable tie to the handle, and a strap receiving channel. The mounting section is adapted to hold a coupled cable tie. The mounting section partially defines a socket adapted for receiving a locking head of a cable tie and securing the cable tie to the handle.

A cable tie having a one-piece flexible strap with ratchet teeth is utilized to clamp an open end of a bag. The cable tie generally includes a locking head and a long flexible strap tail with ratchet teeth on one of its flat surfaces. The elongated strap includes a proximal end, a distal end, a top planar surface and a bottom planar surface. The strap further includes a plurality of teeth which are formed along the strap and which protrude above the top planar surface of the strap. The teeth are spaced along the length of the strap. The locking head is integrally formed to a proximal end of the elongated strap. The locking head comprises a housing having a strap receiving opening through which the distal end of the strap passes, and a locking means which projects inwardly from opposite sides of the side walls of the housing and on the side of the locking head for interacting with the teeth of the strap. The distal end of the strap is further advanced to wrap around the open end of the sandbag and is inserted through the strap receiving opening to form a loop. As the insertion force of the distal end is relaxed, the stored pressure of the sandbag strap receiving opening by virtue of its configuration pushes against the bottom surface causing the strap to pivot.

The mounting section further comprises a strap receiving aperture that extends downwardly from the bottom end of the socket and is shaped to accept a strap of the cable tie. The distal end of the strap is inserted through the socket and is further advanced through the strap receiving aperture of the mounting section until the locking head is held in place within the socket. The handle further comprises a strap receiving channel that extends from a rear surface of the handle through the lower panel of the handle. The strap receiving channel is adapted for receiving the strap of the cable tie. After the distal end of the strap passes through the socket and through the strap receiving aperture of the mounting section, the strap is looped around an open end of a sandbag to tie the opening thereof, and then passes through the strap receiving channel and through the strap receiving opening of the cable tie to form a loop. An entry portion of the strap receiving channel is formed through the lower panel of the handle and is connected to an exit portion of the strap receiving channel formed at the surface of the handle adjacent to the socket. After the distal end of the strap passes through the strap receiving channel from the rear surface of the handle, the distal end is inserted and further advanced through the strap receiving opening of the cable tie that resides in the socket. The length of the strap is adjustable by pulling the distal end of the strap until the top planar surface of the strap is firmly tightened against the bag desired for transport.

### BRIEF DESCRIPTION OF DRAWINGS

For a better understanding of the present invention, reference may be made to the accompanying drawings.

FIG. 1 is a perspective view of a typical sandbag capable of utilizing the present reusable handle with a cable tie constructed in accordance with the teachings of the present invention.

FIG. 2 is a front view of the handle of FIG. 1.

FIG. 3 is a top plan view of the handle of FIG. 1.

FIGS. 4-6 are side cross-section views of the handle of FIGS. 1 and 2 with a cable tie, showing installation of the cable tie with the handle, taken along line 4-4 of FIG. 2.

It should be understood that the drawings are not necessarily to scale and that the embodiments disclosed herein are sometimes illustrated by fragmentary views. In certain instances, details which are not necessary for an understanding of the present invention or which render other details difficult to perceive may have been omitted. It should be understood that the invention is not necessarily limited to the particular embodiments illustrated herein. Like numbers utilized throughout the various figures designate like or similar parts or structure.

### DETAILED DESCRIPTION OF THE INVENTION

The present invention is generally embodied in a handle with a cable tie assembly having a mounting section and a socket formed in the mounting section, adapted for carrying an article or bag, such as a sandbag. The cable tie removably coupled to the handle is wrapped around an open end of a sandbag such that the sandbag is bound by the cable tie. Any disposable cable tie can be used with the handle as long as a locking head of a cable tie can be positioned in the socket of the mounting section. After the flood has subsided, the cable tie could simply be cut off and the handle could be reused the next time bad weather threatens.

The handle with a cable tie assembly 10 of the present invention generally comprises a handle 14 coupleable with a cable tie 12. A handle 14 is connected to an open end of a bag 100 by means of a cable tie 12 to provide a bag carrying system.

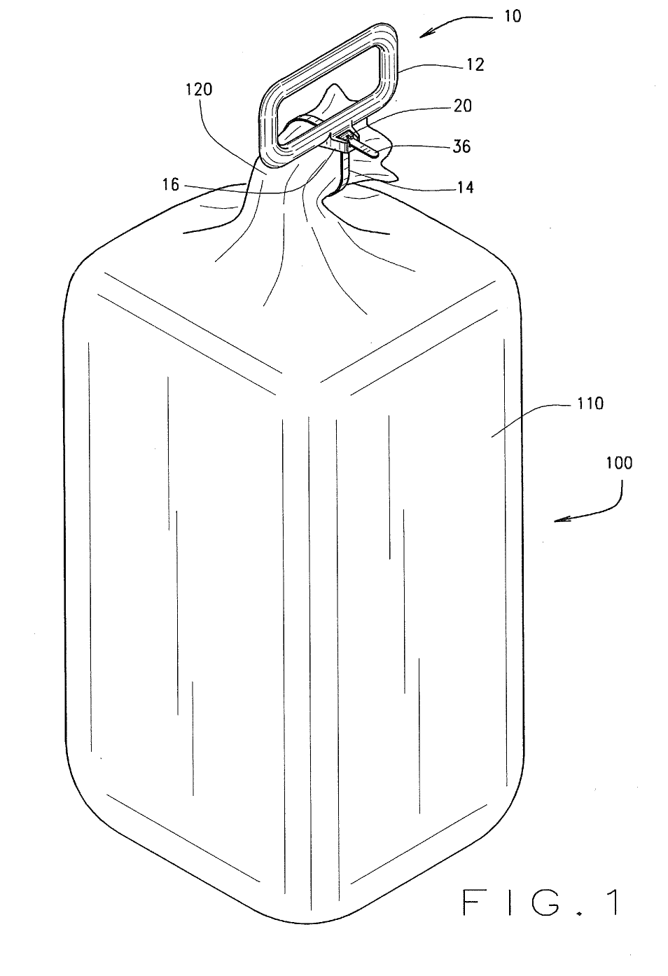

Referring now to the drawings, FIG. 1 illustrates a typical sandbag 100 bound by a cable tie 12 coupled with a reusable handle 14 of the present invention. For illustrative purposes only, use of the present reusable handle with a cable tie assembly 10 will be discussed with references to the sandbag 100 illustrated in FIG. 1. A typical sandbag 100 comprises a bag 110 generally made of a fabric material, like a burlap or plastic material, and have one open end 120 designed to be filled with material, such as particulate material, like sand or soil (not shown). The open end 120 of the filled sandbag 100 is then usually sealed, such as by using a bag tie, and then the sandbag 100 is transported to a desired position. The open end 120 of the sandbag 100 is bound by a cable tie 12 coupled with a handle 14 for transportation. As used herein, upper, lower, forwardly and other position terms are used to describe the invention as oriented in the drawings. Orientation terms, as used herein, are for orientation of the reusable handle assembly as oriented in FIG. 2.

FIGS. 2 and 3 illustrate a handle with a cable tie assembly 10 of the present invention. The handle 14 generally comprises a body 15 and a mounting section 16 adapted for connecting a cable tie 12 to the handle 14. The body 15 of the handle 14 includes a lower panel 18, an upper panel 19, and two side panels 20, which form a carrying loop. In one embodiment, the mounting section 16 extends forwardly from the lower panel 18 of the body 15, preferably at an approximately right angle. The mounting section 16 is generally adapted to hold a coupled cable tie 12 in place. The mounting section 16 partially defines a socket 22 formed adjacent the center of the mounting section 16. The socket 22 adapted for receiving a locking head 24 of a cable tie 12 and securing the cable tie 12 to the handle 14, is provided to allow the socket 22 to fit over the outer surface of the locking head 24. Preferably, the inner surface of the socket 22 is flat, however, it can be curved or conform to the shape of the outer surface of the locking head 24.

The mounting section 16 extends from the lower panel 18 of the body 15. The upper panel 19 of the body 15 can be used as a hand-grip portion 19. The hand-grip portion 19 with the carrying loop formed by the body 15 is configured for a hand-suspension of the sandbag 100, and the hand grip portion 19 identifies the hand-grip region of the carrying loop.

The handle 14 can be formed in many shapes, including oval, circular, rectangular and triangular. In one embodiment, the handle 14 has a substantially rectangular shape, which includes a top gripping member, two side members and a bottom member. In a further embodiment, the handle 14 may be provided with additional strength and reinforcement 25, such as a metal wire reinforcement along the length of the handle 14. The elements of the handle 14 preferably are comprised of a plastic such as polypropylene, nylon or a phenolic resin. However, it is also within the scope of the present invention to construct the handle 14 of a metal such as aluminum, stainless steel or the like. Also, the handle 14 can be formed as one continuous piece, or two or more separate elements can be attached to one another by a conventional attachment method such as welding or the like.

Cable tie 12, illustrated in FIGS. 1 and 2, is generally a one piece tie comprising an elongated strap 26 and a locking head 24. The elongated strap 26 is constructed of a flexible material such as plastic, nylon or a high modulus elastomer and includes a proximal end 28, a distal end 30, a top planar surface and a bottom planar surface. The strap 26 further includes a plurality of teeth 32 which are formed along the strap 26 and which protrude above the top planar surface of strap 26. The teeth 32 are spaced along the length of strap 26. The locking head 24 is integrally formed to the proximal end 28 of the elongated strap 26. The locking head 24 comprises a housing 34 having a strap receiving opening 36 through which the distal end 30 of the strap 26 passes, and a locking means (not shown) which project inwardly from opposite sides of the side walls of the housing 34 and on the side of the locking head 24 for interacting with the teeth 32 of the strap 26. The locking means (not shown) projects out from the inner end wall of the housing 34 into the strap receiving opening 36 in the direction of the outer end wall. The distal end 30 of the strap 26 is wrapped around the open end 120 of the sandbag 100 and is inserted through the strap receiving opening 36 to form a loop. The distal end 30 of the strap 26 is further advanced through the strap receiving opening 36 to reduce the size of the loop, drawing the tie tight around the open end of the sandbag 100. As the insertion force of the distal end 30 is relaxed, the stored pressure of the strap receiving opening 36 by virtue of its configuration, pushes against the bottom surface causing the strap 26 to pivot. As the strap 26 pivots, the rear surface of one of the teeth 32 abuts against angled locking means to lock the tie in place around the sandbag 100.

The cable tie 12 includes a sturdy plastic cord or strap 26 with an integrated gear rack or teeth 32. Once the distal end 30 of the cable tie 12 has been pulled through the strap receiving opening 36 and past the teeth 32, it is prevented from being pulled back such that the worker ties the filled sandbag 100.

The mounting section 16 defines a socket 22 formed adjacent the center of the mounting section 16 such that the cable tie can slip into the socket 22. The socket 22 adapted for accepting a locking head 24 of a cable tie 12 and securing the cable tie 12 to the handle 14, is generally shaped for the locking head 24 of the cable tie 12 to be fitted into the socket 22 and typically formed in a mounting section 16 that extends from the lower panel 18 of the. handle 14. Extending below the socket 22 is a strap receiving aperture 38. The mounting section 16 defines the strap receiving aperture 38 that extends downwardly from the bottom end of the socket 22 and is shaped to accept a strap 26 of the cable tie 12. The strap receiving aperture 38 is dimensioned such that the strap 26 of a cable tie 12 can fit therethrough. The strap 26 is inserted through the socket 22 and is further advanced through the strap receiving aperture 38 of the mounting section 16 until a locking head of the cable tie 12 is coupled within the socket 22.

The handle 14 and the mounting section 16 further defines a strap receiving channel 40 that extends horizontally from the socket 22 to a rear surface of the handle 14 through the lower panel 18 of the handle 14. The strap receiving channel 40 is also dimensioned such that the strap 26 of a cable tie 12 can fit therethrough. The strap receiving channel 40 comprises an entry portion 41 and an exit portion 42, connected by the lower panel 18 of the handle 14. The entry portion 41 and the exit portion 42 of the strap receiving channel 40 are defined through the lower panel 18 of the handle 14. The strap 26 is inserted through the entry portion 41 and the exit portion 42, and is further advanced through the strap receiving opening 36 of the cable tie 12, which resides within the socket 22 of the mounting section 16.

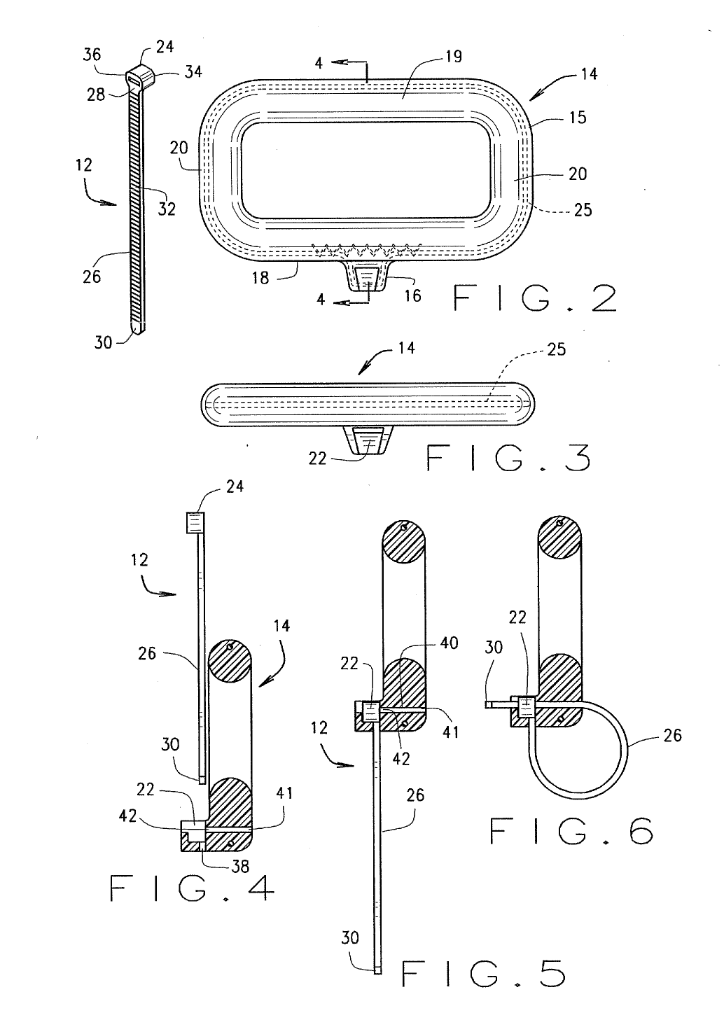

FIGS. 4-6 illustrate various side cross-section views of one embodiment of a reusable handle 14 with a cable tie 12 constructed in accordance with the teachings of the present invention. As illustrated in FIG. 4, the cable tie 12 drops into the socket. The distal end 30 of the strap 26 is inserted through the socket 22 and is further advanced through the strap receiving aperture 38 of the mounting section 16 until the locking head 24 is held in place within the socket 22. After the distal end 30 of the strap 26 passes through the socket 22 and through strap receiving aperture 38 of the mounting section 16, the strap 26 is looped about an open end of a sandbag 100 to tie the opening thereof, and then passes through the strap receiving channel 40 and through the strap receiving opening 36 of the cable to form a loop. An entry portion 41 of the strap receiving channel 40 formed through the lower panel 18 of the handle 14 is connected to an exit portion 42 of the strap receiving channel 40. After the distal end 30 of the strap 26 passes through the entry portion 41 of the strap receiving channel 40 from the rear surface of the handle 14, the distal end 30 is inserted through the exit portion 42 and then the strap 26 is further advanced through the strap receiving opening 36 of the cable tie 12 that resides in the socket 22. The length of the strap 26 is adjustable by pulling the distal end 30 of the strap 26 until the top planar surface of the strap 26 is firmly tightened against the bag desired for transport.

It is recognized that the reusable handle can be removed either by cutting the tie or actuating a release mechanism. Although only one embodiment of the release mechanism (cutting off) associated with the present reusable handle has been disclosed herein, it is recognized that a wide variety of different types of release mechanisms can be utilized to release the handle from the locked cable tie.

Although the present product merchandising system has been described with respect to use with a sandbag, it is recognized that the present reusable handle with a cable tie could be utilized in any bag or article, especially those that may require minimal security.

Thus, there has been shown and described several embodiments of a reusable handle with a cable tie, which apparatus fulfills all of the objects and advantages sought therefore. Many changes, modifications, variations and other uses and applications of the present constructions will, however, become apparent to those skilled in the art after considering this specification and the accompanying drawings. All such changes, modifications, variations and other uses and applications which do not depart from the spirit and scope of the present invention are deemed to be covered by the invention.

What is claimed is:

1. A reusable handle for use with a disposable cable tie, the cable tie including a strap having a proximal end, distal end and a plurality of raised teeth spaced along its length, a locking head integrally formed to the proximal end of the strap, a strap receiving opening formed within the locking head, and a locking means disposed within the locking head and adapted for locking the elongated flexible strap, the reusable handle comprising:
a body having a hand-grip portion and a strap receiving channel defined therein; and
a mounting section attached to the body, the mounting section including a socket defined therein and adapted for receiving a cable tie such that a locking head of the cable tie is held in place within the socket,
whereby a distal end of the strap is inserted through the socket, through the strap receiving channel and through the strap receiving opening of the cable tie to form a loop such that the strap is locked within the locking head.

2. The reusable handle for use with a cable tie of claim 1, wherein the body includes metal reinforcement along the length of the body.

3. The reusable handle for use with a cable tie of claim 1, wherein the mounting section further comprises a strap receiving aperture connected to the socket, whereby the distal end of the strap is inserted through the socket and through the strap receiving aperture.

4. The reusable handle for use with a cable tie of claim 1, wherein the strap receiving channel is connected to the socket, whereby the distal end of the strap is inserted through the strap receiving channel and through the strap receiving opening held in place within the socket.

5. A carrying handle assembly comprising:
a disposable cable tie including:
a strap having a proximal end, distal end and a plurality of raised teeth spaced along its length;
a locking head integrally formed to the proximal end of the strap;
a strap receiving opening formed within the locking head;
a locking means disposed within the locking head and adapted for locking the strap; and
a reusable handle including:
a body having a hand-grip portion and a strap receiving channel defined therein; and
a mounting section attached to the body, the mounting section including a socket defined therein and adapted for receiving a cable tie such that a locking head of the cable tie is held in place within the socket; and
whereby a distal end of the strap is inserted through the socket, through the strap receiving channel and through the strap receiving opening of the cable tie to form a loop such that the strap is locked within the locking head.

6. The carrying handle assembly of claim 5, wherein the body includes metal reinforcement along the length of the body.

7. The carrying handle assembly of claim 5, wherein the mounting section further comprises a strap receiving aperture connected to the socket, whereby the distal end of the strap is inserted through the socket and through the strap receiving aperture.

8. The carrying handle assembly of claim 5, wherein the strap receiving channel is connected to the socket, whereby the distal end of the strap is inserted through the strap receiving channel and through the strap receiving opening held in place within the socket.

9. A reusable handle designed to receive a disposable cable tie to facilitate closure of the sandbag which is thereafter manually transported to a desired location, the reusable handle comprising:
means for receiving a human hand and receiving the disposable cable tie, the tie closing the sandbag for manual transport to a desired location; and
means for reinforcing the reusable handle.

10. In combination a single use sandbag, a single use cable tie and a reusable handle, the combination comprising:
means for receiving a human hand and receiving the disposable cable tie, the tie closing the sandbag for manual transport to a desired location; and
said receiving means being reusable after the sandbag is no longer needed and the cable tie has been cut and removed from the reusable handle.
